(19) United States
(12) Patent Application Publication
(10) Pub. No.: US 2026/0266185 A1
(43) Pub. Date: Sep. 10, 2026

(54) GAS TURBINE ENGINE ROTOR STAGE WITH ROTOR BLADE DAMPER ARRANGEMENT

(71) Applicant: RTX Corporation, Farmington, CT (US)

(72) Inventors: David E. Gambardella, Tucson, AZ (US); Benjamin B. Simpson, Rogersville, TN (US); Jeffrey S. Beattie, South Glastonbury, CT (US)

(21) Appl. No.: 19/070,438

(22) Filed: Mar. 4, 2025

(51) Int. Cl. F01D 5/22; F01D 11/00

(52) U.S. Cl. CPC F01D 5/22; F01D 11/006; F05D 2240/30; F05D 2240/80; F05D 2260/96

(57) ABSTRACT

A rotor stage for a gas turbine engine is provided that includes a disk, first and second rotor blades, a platform seal, and a damper. The first and second rotor blades are attached to the disk and adjacent. The first rotor blade has a first neck portion and a first platform, and the second rotor blade has a second neck portion and a second platform. The first rotor blade has a first lateral rail that extends laterally outward from a first neck portion surface, and has a first damper post that extends laterally outward from the first neck portion surface. The second rotor blade has a second lateral rail that extends laterally outward from a second neck portion surface, and has a second damper post that extends laterally outward from the second neck portion surface. The damper is circumferentially disposed between the first and second lateral rails.

This invention was made with Government support under Contract N00019-21-G-0005/N00019-23-F-0019 awarded by the United States Navy. The Government has certain rights in this invention.

### BACKGROUND OF THE INVENTION

### 1. Technical Field

The present disclosure relates to gas turbine engines in general, and to rotor stages having inter-blade vibration dampers and seals in particular.

### 2. Background Information

Gas turbine engines typically include more than one turbine rotor stage that includes a plurality of rotor blades extending radially outward from a disk. Each rotor blade typically includes a platform and the platforms in the stage define an inner radial gas path boundary. Very often, a seal will be disposed to seal between platform segments of adjacent rotor blades; i.e., to prevent gas passing between the platform edges of the adjacent blades. In some embodiments, a damper will be utilized in combination with the seal. The damper provides vibrational damping for the adjacent rotor blades and may coordinate with the platform seal to position the seal. The time and cost to design and test such seals and dampers can be prohibitive. It would be very useful to have a rotor stage sealing system that has applicability for a plurality of different rotor stages.

### SUMMARY

According to an aspect of the present disclosure, a rotor stage for a gas turbine engine is provided that includes a disk, a first rotor blade, a second rotor blade, a platform seal, and a damper. The first and second rotor blades are attached to the disk so they are adjacent one another. The first rotor blade has a first neck portion and a first platform, and the second rotor blade has a second neck portion and a second platform. The first rotor blade has a first lateral rail that extends laterally outward from a first neck portion surface, and has a first damper post that extends laterally outward from the first neck portion surface. The second rotor blade has a second lateral rail that extends laterally outward from a second neck portion surface, and has a second damper post that extends laterally outward from the second neck portion surface. The damper is circumferentially disposed between the first and second lateral rails, and axial movement of the damper is constrained by the first and second damper posts.

In any of the aspects or embodiments described above and herein, the first neck portion surface may be disposed on a pressure side of the first rotor blade, and the second neck portion surface may be disposed on a suction side of the second rotor blade. The first platform may extend laterally outward from the first neck portion surface, and the second platform may extend laterally outward from the second neck portion surface.

In any of the aspects or embodiments described above and herein, the first platform may include a first inner radial surface and a first forward tang, and the second platform may include a second inner radial surface and a second forward tang. A forward edge of the damper may be disposed radially between the first inner radial surface and the first forward tang, and radially between the second inner radial surface and the second forward tang.

In any of the aspects or embodiments described above and herein, the damper may be disposed radially between first damper post and the first inner radial surface, and may be disposed radially between second damper post and the second inner radial surface.

In any of the aspects or embodiments described above and herein, the damper may include a first side damper tang extending outwardly adjacent a first lateral side of the damper, and a second side damper tang extending outwardly adjacent a second lateral side of the damper, wherein the second lateral side is opposite the first lateral side.

In any of the aspects or embodiments described above and herein, axial movement of the damper may be constrained by the first damper post engaging with the first side damper tang and the second damper post engaging with the second side damper tang.

In any of the aspects or embodiments described above and herein, the first lateral rail may extend laterally outward from the first neck portion surface by a first lateral distance, and the first damper post may extend laterally outward from the first neck portion surface by a second lateral distance, and the second lateral distance may be greater than the first lateral distance.

In any of the aspects or embodiments described above and herein, the second lateral rail may extend laterally outward from the second neck portion surface by the first lateral distance, and the second damper post may extend laterally outward from the second neck portion surface by the second lateral distance.

In any of the aspects or embodiments described above and herein, the damper may include an outer radial surface and an inner radial surface, and the first side damper tang and the second side damper tang may extend outwardly from the inner radial surface.

In any of the aspects or embodiments described above and herein, the damper may be configured to locate the platform seal.

In any of the aspects or embodiments described above and herein, the damper may include a channel disposed in the outer radial surface, and the channel may be configured to receive the platform seal.

In any of the aspects or embodiments described above and herein, the first lateral rail and the first damper post may be integral with one another, or the first lateral rail and the first damper post may be independent of one another.

According to an aspect of the present disclosure, a gas turbine engine is provided that includes a compressor section, a combustor section, and a turbine section. The turbine section has a first rotor stage and a second rotor stage. The first rotor stage includes a disk, a first rotor blade, a second rotor blade, a platform seal, and a damper. The first and second rotor blades are attached to the disk so they are adjacent one another. The first rotor blade has a first neck portion and a first platform, and the second rotor blade has a second neck portion and a second platform. The first rotor blade has a first lateral rail that extends laterally outward from a first neck portion surface, and has a first damper post that extends laterally outward from the first neck portion surface. The second rotor blade has a second lateral rail that extends laterally outward from a second neck portion surface, and has a second damper post that extends laterally outward from the second neck portion surface. The damper is circumferentially disposed between the first and second lateral rails, and axial movement of the damper is constrained by the first and second damper posts.

In any of the aspects or embodiments described above and herein, the second rotor stage (SRS) may include an SRS disk, an SRS first rotor blade, and an SRS second rotor blade. The SRS first and second rotor blades are attached to the SRS disk so they are adjacent one another. The SRS first rotor blade has an SRS first neck portion and an SRS first platform, and the SRS second rotor blade has an SRS second neck portion and an SRS second platform. The SRS first rotor blade has an SRS first lateral rail that extends laterally outward from an SRS first neck portion surface, and has an SRS first damper post that extends laterally outward from the SRS first neck portion surface. The SRS second rotor blade has an SRS second lateral rail that extends laterally outward from an SRS second neck portion surface, and has an SRS second damper post that extends laterally outward from the SRS second neck portion surface. The SRS first lateral rail extends laterally outward from the SRS first neck portion surface by a third lateral distance, and the SRS first damper post extends laterally outward from the SRS first neck portion surface by a fourth lateral distance. The third lateral distance may be greater than the first lateral distance, and the fourth lateral distance may be greater than the second lateral distance.

In any of the aspects or embodiments described above and herein, the damper may include a channel configured to locate the platform seal.

The foregoing features and elements may be combined in various combinations without exclusivity, unless expressly indicated otherwise. For example, aspects and/or embodiments of the present disclosure may include any one or more of the individual features or elements disclosed above and/or below alone or in any combination thereof. These features and elements as well as the operation thereof will become more apparent in light of the following description and the accompanying drawings. It should be understood however; the following description and drawings are intended to be exemplary in nature and non-limiting.

### BRIEF DESCRIPTION OF THE DRAWINGS

FIG. 1 is a diagrammatic sectional view of a gas turbine engine embodiment.

FIG. 2 is a diagrammatic sectional view of a portion of a turbine section.

FIG. 3 is a diagrammatic side view of a rotor blade.

FIG. 3A is a diagrammatic front view of the rotor blade shown in FIG. 3.

FIG. 4 is a diagrammatic side view showing a portion of a rotor blade according to an embodiment of the present disclosure.

FIG. 5 is a diagrammatic top view showing a portion of a rotor blade according to an embodiment of the present disclosure.

FIG. 5A is a diagrammatic top view showing a portion of a rotor blade according to an embodiment of the present disclosure.

FIG. 6 is a diagrammatic end view showing an embodiment of the present disclosure.

FIG. 7 is a diagrammatic side view showing an embodiment of the present disclosure.

FIG. 8 is a diagrammatic top view showing an embodiment of the present disclosure.

FIG. 8A is a diagrammatic top view showing an embodiment of the present disclosure.

FIG. 9 is a diagrammatic end view showing an embodiment of the present disclosure.

FIG. 9A is a diagrammatic end view showing an embodiment of the present disclosure.

### DETAILED DESCRIPTION

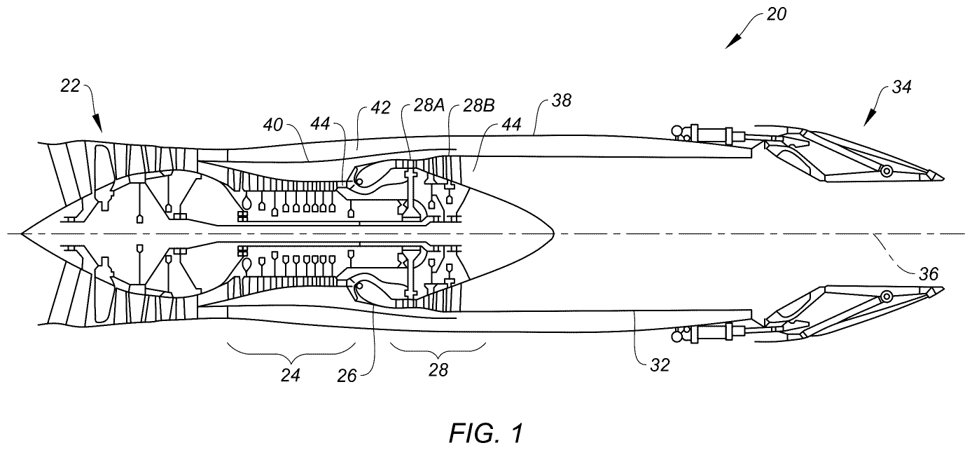

FIG. 1 diagrammatically illustrates a gas turbine engine 20. The gas turbine engine 20 is disclosed herein as a two-spool low-bypass turbofan that generally incorporates a fan section 22, a compressor section 24, a combustor section 26, a turbine section 28 (HPT 28A, LPT 28B), an exhaust duct section 32, and a nozzle 34 disposed along a longitudinal engine axis/centerline 36. The gas turbine engine 20 is disposed in a nacelle 38. Although the gas turbine engine 20 is shown as a low bypass turbofan in FIG. 1, it should be understood that the concepts described herein are not limited to use with a low bypass turbofan, and may be used with a variety of different gas turbine engine architectures, including geared architecture engines, direct drive turbofans, turbojet, turboshaft, multi-stream variable cycle adaptive engines and other engine architectures. The gas turbine engine 20 diagrammatically shown in FIG. 1 further includes an engine case 40 disposed radially outside of the compressor, combustor, and turbine sections 24, 26, 28 of the engine 20 and radially inside of (and spaced apart from) the nacelle 38. A generally annular secondary airflow path 42 is disposed between the engine case 40 and the nacelle 38. A gas path (referred to herein as the “core gas path 44”) extends through the compressor, combustor, and turbine sections 24, 26, 28.

A portion of the air that enters the engine 20 (i.e., the “inlet air”), passes through the fan section 22 and enters the secondary airflow path 42. This portion of the inlet air may be referred to as “bypass airflow”. The remaining portion of the inlet air enters the core gas path 44. More specifically, this portion of the inlet air enters the compressor section 24 where it is worked to a higher pressure and temperature. The now “worked” air subsequently enters the combustor section 26 where fuel is added and the mixture is combusted. The gaseous combustion products and any non-combusted air passes to the turbine section 28. To facilitate the description herein, air passing through the compressor section 24 and into the combustor section 26, and the gaseous combustion byproducts passing through the turbine section 28 will all be referred to herein as “core gas flow”, unless otherwise noted. The bypass air flow and the core gas flow are both directed through the nozzle 34 to produce useful thrust.

The terms “forward”, “leading”, “aft, “trailing” are used herein to indicate the relative position of a component or surface. As air passes through the engine 20, a leading edge of a stator vane or rotor blade encounters the air before the trailing edge of the same. In a conventional axial engine such as that shown in FIG. 1, the fan section 22 is forward of the compressor section 24 and the turbine section 28 is aft of the compressor section 24. The terms “inner radial” and “outer radial” refer to relative radial positions from the engine centerline 36.

An inner radial component or path is disposed radially closer to the engine centerline 36 than an outer radial component or path.

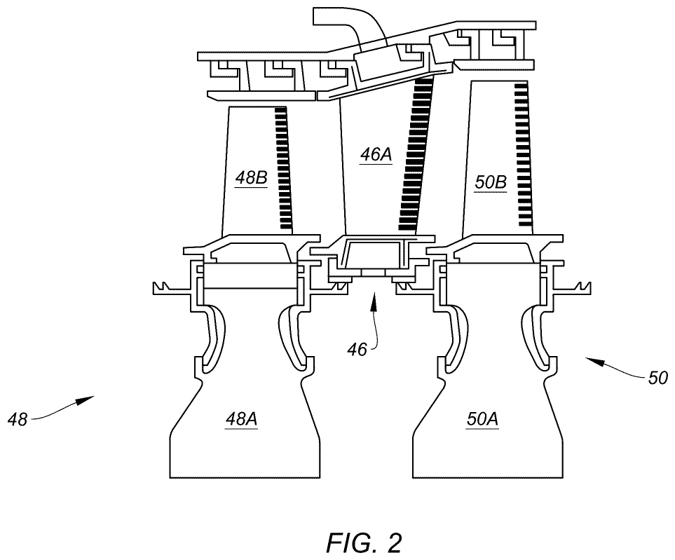

FIG. 2 diagrammatically illustrates a portion of a turbine section 28. The portion includes a turbine vane stage 46 disposed axially between a first turbine rotor stage 48 and a second turbine rotor stage 50. The turbine vane stage 46 is an annular structure that includes a plurality of stator vanes 46A. The first turbine rotor stage 48 includes a rotor having a disk 48A and a plurality rotor blades 48B extending radially out from the disk 48A. The second turbine rotor stage 50 includes a rotor having a disk 50A and a plurality rotor blades 50B extending radially out from the disk 50A.

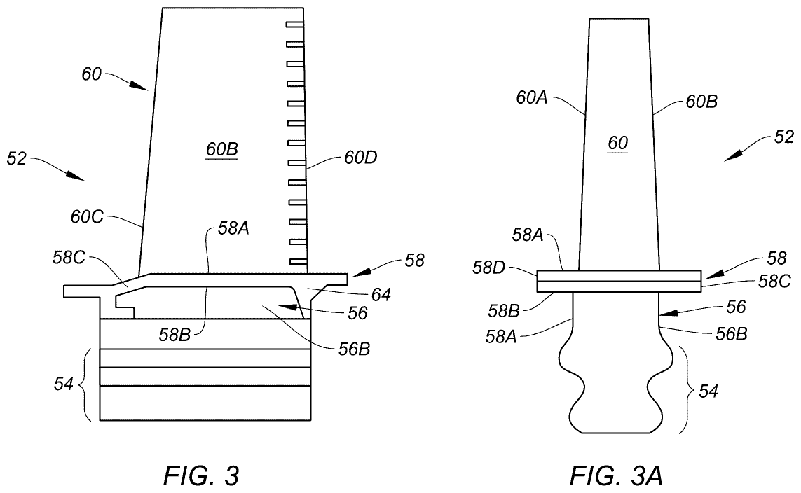

FIG. 3 is a diagrammatic side view and FIG. 3A is a diagrammatic front view of a rotor blade 52 that may be used in a rotor stage 48, 50 as shown in FIG. 2. The rotor blade 52 includes a root 54, a neck portion 56, a platform 58, and an airfoil 60. The root 54 is configured for mating attachment with a rotor disk. The neck portion 56 extends between the root 54 and the platform 58 and has a suction side surface 56A and a pressure side surface 56B. The airfoil 60 extends outwardly from the platform 58 (opposite the neck portion 56), and has a suction side surface 60A and a pressure side surface 60B. The airfoil 60 extends from a leading edge 60C to a trailing edge 60D. The platform 58 may extend outwardly in a forward direction (i.e., in a direction away from the airfoil leading edge 60C) and in an aft direction (i.e., in a direction away from the airfoil trailing edge 60D). The platform 58 extends laterally outward from the neck portion 56 on the pressure side of the rotor blade 52 and laterally outward from the neck portion 56 on the suction side of the rotor blade 52. The platform 58 has an outer radial surface 58A, an inner radial surface 58B, a pressure side lateral edge surface 58C, and a suction side lateral edge surface 58D. The platform 58 of the rotor blade embodiment shown in FIG. 3 includes a forward tang 62 and an aft wall 64. The forward tang 62 is configured to form a shelf surface disposed beneath a portion of the platform 58.

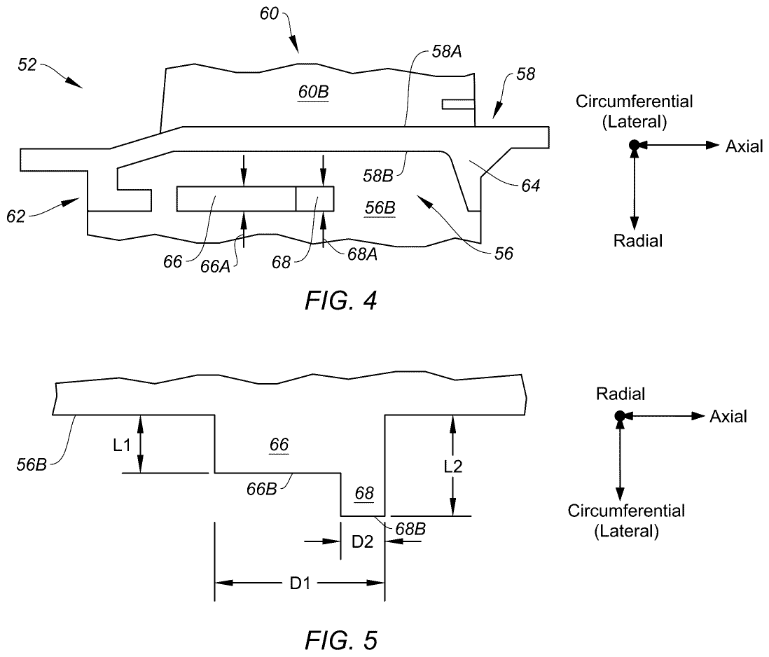

FIG. 4 is a diagrammatic side view of a portion of a rotor blade embodiment, showing a segment of the platform 58 and the neck portion 56 of the rotor blade 52 on the pressure side of the rotor blade 52. The platform 58 segment, including the forward tang 62 and the aft wall 64, extends laterally outward from the pressure side surface 56B of the neck portion 56. The region defined by the inner radial surface 58B of the platform 58, the forward tang 62 and the aft wall 64 is sometimes referred to as a “platform pocket”.

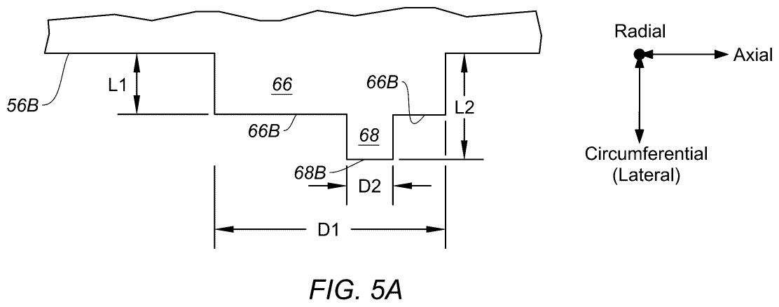

FIG. 4 diagrammatically illustrates a lateral rail 66 and a damper post 68 that extend laterally outward from the pressure side surface 56B of the neck portion 56. FIG. 4 also diagrammatically illustrates a radial thickness 66A of the lateral rail 66 and a radial thickness 68A of the damper post 68. In FIG. 4, the radial thickness 66A of the lateral rail 66 is diagrammatically shown as equal to the radial thickness 68A of the damper post 68. The present disclosure does not require the lateral rail 66 and the damper post 68 to have equal radial thicknesses. For example, in some embodiments the lateral rail 66 may have a radial thickness 66A that exceeds the radial thickness 68A of the damper post 68. Moreover, the radial thickness 66A of the lateral rail 66 may extend radially outside of the damper post 68, or radially inside of the damper post 68, or some combination thereof. Referring to FIG. 5, in some embodiments the lateral rail 66 extends axially a distance D1 and the damper post 68 extends axially a distance D2, wherein D2<D1. FIG. 5A illustrates an embodiment wherein the lateral rail 66 extends axially on both sides of the damper post 68. Referring back to FIG. 5, the lateral rail 66 extends laterally (i.e., in a circumferential direction) out from the pressure side surface 56B of the neck portion 56 a distance L1; i.e., the outer lateral surface 66B of the lateral rail 66 is disposed a distance L1 from the pressure side surface 56B of the neck portion 56. The damper post 68 extends laterally (i.e., in a circumferential direction) out from the pressure side surface 56B of the neck portion 56 a distance L2 (wherein L2>L1); i.e., the outer lateral surface 68B of the damper post 68 is disposed a distance L2 from the pressure side surface 56B of the neck portion 56. The present disclosure also includes a lateral rail 66 and a damper post 68 that extend laterally outward from the suction side surface 56A of the neck portion 56. The configuration of the lateral rail 66 and the damper post 68 on the pressure side (e.g., L1_{PS}, L2_{PS}) and the configuration of the lateral rail 66 and the damper post 68 on the suction side (e.g., L1_{SS}, L2_{SS}) may be the same (i.e., L1_{PS}=L1_{SS} and L2_{PS}=L2_{SS}) or they may be different (e.g., L1_{PS}>L1_{SS} and L2_{PS}>L2_{SS}).

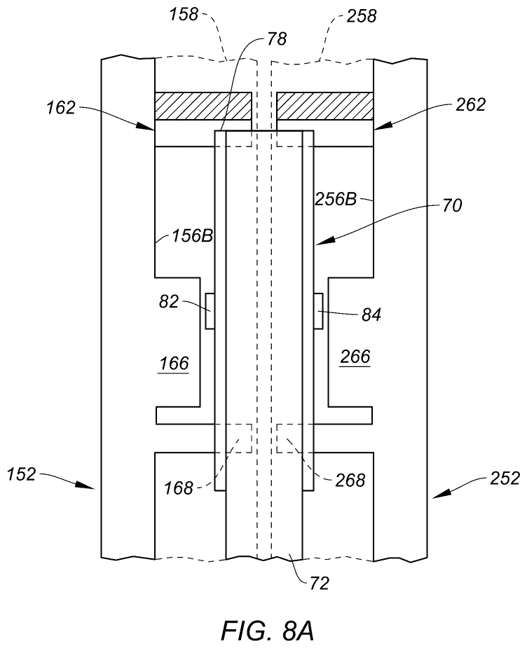

In FIGS. 4, 5, and 8, the lateral rail 66 and the damper post 68 are diagrammatically shown as an integral pair. The present disclosure does not require that the lateral rail 66 and the damper post 68 be attached or integral with one another. For example, lateral rail 66 and the damper post 68 may each independently extend laterally outward from the neck portion 56; e.g., see FIG. 8A.

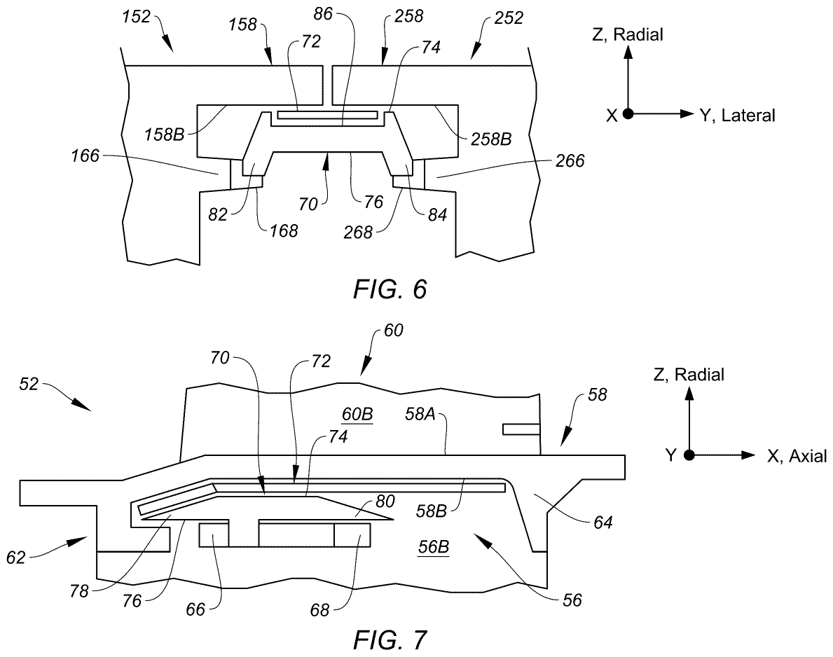

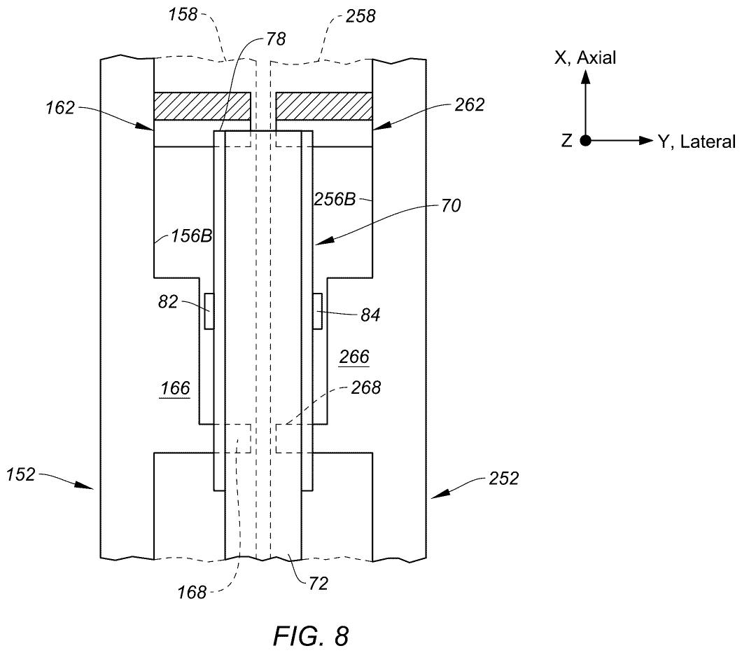

FIG. 6 diagrammatically illustrates a pair of adjacent (i.e., side by side) rotor blades as they would be positioned when installed in a rotor disk. The rotor blade on the left (referred to hereinafter as the “first rotor blade 152”) includes a platform segment 158 that extends laterally outward from the pressure side of the first rotor blade 152, and the rotor blade on the right (referred to hereinafter as the “second rotor blade 252”) includes a platform segment 258 that extends laterally outward from the suction side of the second rotor blade 252. A damper 70 and a platform seal 72 are shown engaged with the rotor blades 152, 252. FIG. 7 diagrammatically illustrates a side view of a rotor blade 52 with a damper 70 and a platform seal 72 engaged with the rotor blade 52.

Referring to FIGS. 6-8, the damper 70 may be described as having a body with an outer radial surface 74, an inner radial surface 76, a forward edge 78 (see FIG. 7), an aft edge 80 (see FIG. 7), a first side damper tang 82 (see FIG. 6), and a second side damper tang 84 (see FIG. 6). The first and second side damper tangs 82, 84 are disposed on opposite lateral sides of the damper 70 and extend outwardly from the damper body; e.g., outwardly away from the inner radial surface 76. In some embodiments (i.e., like that shown in FIG. 6), the damper 70 may be configured to locate the platform seal 72. For example, the outer radial surface 74 of the damper body may include a channel 86 configured to receive the platform seal 72 and thereby locate the platform seal 72. The platform seal 72 includes an axial length, a lateral width, and a thickness. The platform seal 72 axial length extends in an X-axis direction; see FIG. 7. The platform seal 72 lateral width extends between lateral sides; e.g., in a Y-axis direction; see FIG. 6. The platform seal 72 thickness extends in a Z-axis direction; see FIG. 6. The platform seal 72 length may be configured to conform with the geometry of the inner radial surface 58B of the platform 58.

Referring to FIG. 6, the present disclosure rotor blade damper arrangement is configured to constrain movement of the damper 70 (and the platform seal 72) in a radial direction, in the lateral direction, and in the axial direction.

Referring to FIGS. 6-8, in the present disclosure rotor blade damper arrangement, the body of the damper 70 is disposed radially between the inner radial surfaces 158B, 258B of the first and second rotor blade platforms 158, 258 and the damper posts 168, 268 of the first and second rotor blades 152, 252. Depending upon the axial position of the damper 70, the forward edge 78 of the damper may also is disposed radially between the inner radial surfaces 158B, 258B of the first and second rotor body platforms 158, 258 and the forward tangs 162, 262; e.g., see FIG. 8. The radial movement of the damper 70 is thereby radially constrained.

In the present disclosure rotor blade damper arrangement, the first side damper tang 82 extends laterally outward from the damper body on the first lateral side of the damper 70 and the second side damper tang 84 extends laterally outward from the damper body on the second lateral side of the damper 70. When the present disclosure rotor blade damper arrangement is assembled between the adjacent first and second rotor blades 152, 252, the first and second side damper tangs 82, 84 are disposed between the lateral rail 166 extending out from the neck portion pressure side surface 156B of the first rotor blade 152 and the lateral rail 266 extending out from the neck portion suction side surface 256B of the second rotor blade 252.

Hence, the lateral rails 166, 266 of the adjacent rotor blades 152, 252 and the damper tangs 82, 84 of the damper 70 collectively constrain lateral movement of the damper 70. It should be noted that the lateral extension (e.g., “L1”—see FIG. 5) of a lateral rail can be varied to accommodate different circumferential rotor blade spacing; e.g., the further the adjacent blades are apart, the greater the lateral rail extension distance. In this manner, embodiments of the present disclosure can accommodate circumferential rotor blade spacing without the need to change rotor blade neck portion thickness.

In the present disclosure rotor blade damper arrangement, the first and second side damper tangs 82, 84 of the damper 70, the damper posts 168, 268 of the first and second rotor blades 152, 252, and the forward tangs 162, 262 of the platforms 158, 258 of the first and second rotor blades 152, 252 cooperate to constrain axial movement of the damper 70. Referring to FIGS. 7 and 8, the forward edge 78 of the damper 70 (and the platform seal 72) can be seen engaged with the forward tangs 162, 262 of the platforms 158, 258 of the first and second rotor blades 152, 252. The forward tangs 62 constrain forward axial travel of the damper 70 and platform seal 72. Sufficient axial movement of the damper 70 in an aft axial direction will cause the damper tangs 82, 84 to contact the damper posts 168, 268 extending laterally outward from the first and second rotor blades 152, 154. The damper posts 168, 268 and the damper tangs 82, 84 therefore constrain aft axial travel of the damper 70.

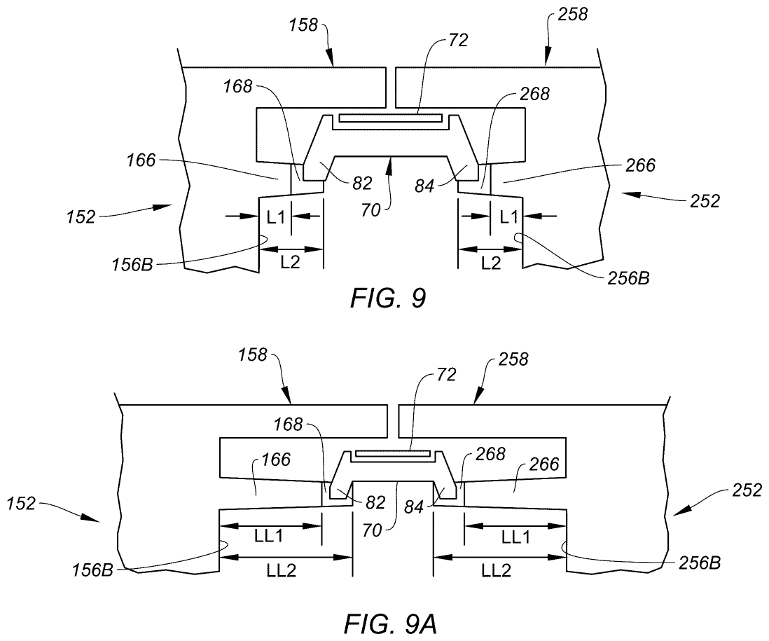

The present disclosure provides a novel and unobvious improved rotor blade damper arrangement that constrains damper 70 movement radially, laterally, and axially. The present disclosure rotor blade damper arrangement also makes it possible to use a given damper 70 configuration in a plurality of different rotor blade pair configurations. Historically, rotor dampers and platform seals are often specifically configured for a given application; e.g., the lateral width of the damper is configured to accommodate the circumferential spacing between adjacent rotor blades. A distinct disadvantage of specifically configuring a damper and/or a platform seal for each application is that the newly designed component must not only be designed, but also tested and manufactured. The design, testing, and manufacturing of multiple different dampers and/or platform seals can be prohibitively expensive. The present disclosure rotor blade damper arrangement is configured such that a particular damper 70 configuration can be used with a plurality of different rotor blade pair configurations; e.g., with different rotor blade circumferential spacing. FIG. 9 diagrammatically illustrates a first and a second rotor blade pair 152, 252 according to an embodiment of the present disclosure. In this embodiment, the lateral rails 166, 266 each extend out from the respective neck portion surface 156B, 256B by a lateral distance L1 and the damper posts 168, 268 each extend out from the respective neck portion surface 156B, 256B by a lateral distance L2; i.e., as is shown in FIG. 5. FIG. 9A diagrammatically illustrates another first and a second rotor blade pair 152, 252 according to an embodiment of the present disclosure. The embodiment shown in FIG. 9A utilizes the same damper 70 and platform seal 72 that is used in the embodiment shown in FIG. 9. In the embodiment shown in FIG. 9A, the circumferential spacing between adjacent rotor blades 152, 252 is greater than the circumferential spacing between adjacent rotor blades 152, 252 shown in FIG. 9. In the embodiment shown in FIG. 9A, the lateral rails 166, 266 each extend out from the respective neck portion surface 156B, 256B by a lateral distance LL1 and the damper posts 168, 268 each extend out from the respective neck portion surface 156B, 256B by a lateral distance LL2, where LL1>L1 and LL2 is greater than L2. The greater lateral distance of the lateral rails 166, 266 in FIG. 9A enable the same damper 70 and platform seal 72 to be used. Hence, under the present disclosure, a damper 70 used with a first rotor stage having “N” number of rotor blades could be used with a second rotor stage having “M” number of rotor blades, wherein “N” and “M” are integers and M<N, thereby increasing the inter-rotor blade spacing.

In addition, the lateral rails 166, 266 may also greatly facilitate tolerancing between the lateral rails 166, 256 and the damper 70. The limited surface area of the outer lateral surface 68B of the lateral rail 66 (see FIG. 5) is substantially less than the surface area of the side surface 56B of the neck portion 56. In many instances, the side surface 56B of the neck portion 56 may be a cast surface and therefore likely not a tolerance planar surface. The outer lateral surface 68B of the lateral rail 66, in contrast, can be readily produced as a flat planar surface at a tolerance distance. In addition, the neck portion 56 (and therefore the side surface 56B) is very likely subject to high stress during operation and therefore susceptible to stress concentrations associated with machining. The present disclosure lateral rail 66 extending laterally out from the neck portion 56 is very likely subject to much lower stresses during operation and therefore substantially less susceptible to stress concentrations. Still further, the lateral rails 66 provide an element that can be readily modified to accommodate changes in the interfacing components; e.g., damper 70.

While the principles of the disclosure have been described above in connection with specific apparatuses and methods, it is to be clearly understood that this description is made only by way of example and not as limitation on the scope of the disclosure. Specific details are given in the above description to provide a thorough understanding of the embodiments.

However, it is understood that the embodiments may be practiced without these specific details.

It is noted that the embodiments may be described as a process which is depicted as a flowchart, a flow diagram, a block diagram, etc. Although any one of these structures may describe the operations as a sequential process, many of the operations can be performed in parallel or concurrently. In addition, the order of the operations may be rearranged. A process may correspond to a method, a function, a procedure, a subroutine, a subprogram, etc.

The singular forms “a,” “an,” and “the” refer to one or more than one, unless the context clearly dictates otherwise. For example, the term “comprising a specimen” includes single or plural specimens and is considered equivalent to the phrase “comprising at least one specimen.” The term “or” refers to a single element of stated alternative elements or a combination of two or more elements unless the context clearly indicates otherwise. As used herein, “comprises” means “includes.” Thus, “comprising A or B,” means “including A or B, or A and B,” without excluding additional elements.

It is noted that various connections are set forth between elements in the present description and drawings (the contents of which are included in this disclosure by way of reference). It is noted that these connections are general and, unless specified otherwise, may be direct or indirect and that this specification is not intended to be limiting in this respect. Any reference to attached, fixed, connected or the like may include permanent, removable, temporary, partial, full and/or any other possible attachment option.

No element, component, or method step in the present disclosure is intended to be dedicated to the public regardless of whether the element, component, or method step is explicitly recited in the claims. No claim element herein is to be construed under the provisions of 35 U.S.C. 112(f) unless the element is expressly recited using the phrase “means for.” As used herein, the terms “comprise”, “comprising”, or any other variation thereof, are intended to cover a non-exclusive inclusion, such that a process, method, article, or apparatus that comprises a list of elements does not include only those elements but may include other elements not expressly listed or inherent to such process, method, article, or apparatus.

While various inventive aspects, concepts and features of the disclosures may be described and illustrated herein as embodied in combination in the exemplary embodiments, these various aspects, concepts, and features may be used in many alternative embodiments, either individually or in various combinations and sub-combinations thereof. Unless expressly excluded herein all such combinations and sub-combinations are intended to be within the scope of the present application. Still further, while various alternative embodiments as to the various aspects, concepts, and features of the disclosures—such as alternative materials, structures, configurations, methods, devices, and components, and so on—may be described herein, such descriptions are not intended to be a complete or exhaustive list of available alternative embodiments, whether presently known or later developed. Those skilled in the art may readily adopt one or more of the inventive aspects, concepts, or features into additional embodiments and uses within the scope of the present application even if such embodiments are not expressly disclosed herein. For example, in the exemplary embodiments described above within the Detailed Description portion of the present specification, elements may be described as individual units and shown as independent of one another to facilitate the description. In alternative embodiments, such elements may be configured as combined elements. It is further noted that various method or process steps for embodiments of the present disclosure are described herein. The description may present method and/or process steps as a particular sequence. However, to the extent that the method or process does not rely on the particular order of steps set forth herein, the method or process should not be limited to the particular sequence of steps described. As one of ordinary skill in the art would appreciate, other sequences of steps may be possible.

1. A rotor stage for a gas turbine engine, comprising:
a disk;
a first rotor blade and a second rotor blade attached to the disk so they are adjacent one another;
wherein the first rotor blade has a first neck portion and a first platform, and the second rotor blade has a second neck portion and a second platform;
wherein the first rotor blade has a first lateral rail that extends laterally outward from a first neck portion surface, and has a first damper post that extends laterally outward from the first neck portion surface;
wherein the second rotor blade has a second lateral rail that extends laterally outward from a second neck portion surface, and has a second damper post that extends laterally outward from the second neck portion surface;
wherein the first lateral rail and the first damper post are spaced apart from and independent of the first platform, and the second lateral rail and the second damper post are spaced apart from and independent of the second platform;
a platform seal; and
a damper;
wherein the damper is circumferentially disposed between the first lateral rail and the second lateral rail; and
wherein axial movement of the damper is constrained by the first damper post and the second damper post.

2. The rotor stage of claim 1, wherein the first neck portion surface is disposed on a pressure side of the first rotor blade, and wherein the second neck portion surface is disposed on a suction side of the second rotor blade; and
wherein the first platform extends laterally outward from the first neck portion surface, and the second platform extends laterally outward from the second neck portion surface.

3. The rotor stage of claim 2, wherein the first platform includes a first inner radial surface and a first forward tang, and the second platform includes a second inner radial surface and a second forward tang; and
wherein a forward edge of the damper is disposed radially between the first inner radial surface and the first forward tang, and radially between the second inner radial surface and the second forward tang.

4. The rotor stage of claim 3, wherein the damper is disposed radially between first damper post and the first inner radial surface, and is disposed radially between second damper post and the second inner radial surface.

5. The rotor stage of claim 4, wherein the damper includes a first side damper tang extending outwardly adjacent a first lateral side of the damper, and a second side damper tang extending outwardly adjacent a second lateral side of the damper, wherein the second lateral side is opposite the first lateral side.

6. The rotor stage of claim 5, wherein axial movement of the damper is constrained by the first damper post engaging with the first side damper tang and the second damper post engaging with the second side damper tang.

7. The rotor stage of claim 6, wherein the first lateral rail extends laterally outward from the first neck portion surface by a first lateral distance, and the first damper post extends laterally outward from the first neck portion surface by a second lateral distance; and
wherein the second lateral distance is greater than the first lateral distance.

8. The rotor stage of claim 7, wherein the second lateral rail extends laterally outward from the second neck portion surface by the first lateral distance, and the second damper post extends laterally outward from the second neck portion surface by the second lateral distance.

9. The rotor stage of claim 6, wherein the damper includes an outer radial surface and an inner radial surface, and the first side damper tang and the second side damper tang extend outwardly from the inner radial surface.

10. The rotor stage of claim 9, wherein the damper is configured to locate the platform seal.

11. The rotor stage of claim 10, wherein the damper includes a channel disposed in the outer radial surface, wherein the channel is configured to receive the platform seal.

12. The rotor stage of claim 1, wherein the first lateral rail and the first damper post are integral with one another.

13. The rotor stage of claim 1, wherein the first lateral rail and the first damper post are independent of one another.

14. A gas turbine engine, comprising:
a compressor section;
a combustor section; and
a turbine section, the turbine section having a first rotor stage and a second rotor stage;
wherein the first rotor stage includes:
a disk;
a first rotor blade and a second rotor blade attached to the disk so they are adjacent one another;
wherein the first rotor blade has a first neck portion and a first platform, and the second rotor blade has a second neck portion and a second platform;
wherein the first rotor blade has a first lateral rail that extends laterally outward from a first neck portion surface, and has a first damper post that extends laterally outward from the first neck portion surface;
wherein the second rotor blade has a second lateral rail that extends laterally outward from a second neck portion surface, and has a second damper post that extends laterally outward from the second neck portion surface;
wherein the first lateral rail and the first damper post are spaced apart from and independent of the first platform, and the second lateral rail and the second damper post are spaced apart from and independent of the second platform;
a platform seal; and
a damper;
wherein the damper is circumferentially disposed between the first lateral rail and the second lateral rail; and
wherein axial movement of the damper is constrained by the first damper post and the second damper post.

15. The gas turbine engine of claim 14, wherein the first neck portion surface is disposed on a pressure side of the first rotor blade, and wherein the second neck portion surface is disposed on a suction side of the second rotor blade; and
wherein the first platform extends laterally outward from the first neck portion surface, and the second platform extends laterally outward from the second neck portion surface; and
wherein the first platform includes a first inner radial surface and a first forward tang, and the second platform includes a second inner radial surface and a second forward tang; and
wherein a forward edge of the damper is disposed radially between the first inner radial surface and the first forward tang, and radially between the second inner radial surface and the second forward tang.

16. The gas turbine engine of claim 15, wherein the damper is disposed radially between first damper post and the first inner radial surface, and is disposed radially between second damper post and the second inner radial surface.

17. The gas turbine engine of claim 16, wherein the damper includes a first side damper tang extending outwardly adjacent a first lateral side of the damper, and a second side damper tang extending outwardly adjacent a second lateral side of the damper, wherein the second lateral side is opposite the first lateral side; and
wherein axial movement of the damper is constrained by the first damper post engaging with the first side damper tang and the second damper post engaging with the second side damper tang.

18. The gas turbine engine of claim 17, wherein the first lateral rail extends laterally outward from the first neck portion surface by a first lateral distance, and the first damper post extends laterally outward from the first neck portion surface by a second lateral distance; and
wherein the second lateral rail extends laterally outward from the second neck portion surface by the first lateral distance, and the second damper post extends laterally outward from the second neck portion surface by the second lateral distance; and
wherein the second lateral distance is greater than the first lateral distance.

19. The gas turbine engine of claim 18, wherein the second rotor stage (SRS) includes:
an SRS disk;
an SRS first rotor blade and an SRS second rotor blade attached to the SRS disk so they are adjacent one another;
wherein the SRS first rotor blade has an SRS first neck portion and an SRS first platform, and the SRS second rotor blade has an SRS second neck portion and an SRS second platform;
wherein the SRS first rotor blade has an SRS first lateral rail that extends laterally outward from an SRS first neck portion surface, and has an SRS first damper post that extends laterally outward from the SRS first neck portion surface;
wherein the SRS second rotor blade has an SRS second lateral rail that extends laterally outward from an SRS second neck portion surface, and has an SRS second damper post that extends laterally outward from the SRS second neck portion surface;
wherein the SRS first lateral rail extends laterally outward from the SRS first neck portion surface by a third lateral distance, and the SRS first damper post extends laterally outward from the SRS first neck portion surface by a fourth lateral distance; and
wherein the third lateral distance is greater than the first lateral distance, and the fourth lateral distance is greater than the second lateral distance.

20. The gas turbine engine of claim 19, wherein the damper includes a channel configured to locate the platform seal.
